(19) United States
(12) Patent Application Publication
(10) Pub. No.: US 2005/0213320 A1
(43) Pub. Date: Sep. 29, 2005

(54) Illuminator

(76) Inventors: Miyashita Kazuhiro, Kaohsiung (TW); Yu-Ping Liu, Kaohsiung (TW); Chao-Fang Chung, Kaohsiung (TW)

Correspondence Address: PRO-TECHTOR INTERNATIONAL SERVICES, 20775 Norada Court, Saratoga, CA, 95070-3018, US

(21) Appl. No.: 10/859,280

(22) Filed: Jun. 1, 2004

(30) Foreign Application Priority Data
Mar. 23, 2004 (TW) 093107854

(51) Int. Cl. F21S 2/00

(52) U.S. Cl. 362/227

(57) ABSTRACT

The present invention of illuminator pertains to converting spot light source, especially light-emitting-diode, into planar light source with some kind of intensity distribution mode, including a spot light source and a reflector, characterized in that spot light source is located at lateral and nook position, and the reflector can be designed elastically according to requirement of mode of reflected light vector distribution in space and mode of reflected light intensity distribution on illuminated surface. Spot light sources of the present invention include light-emitting-diode LCD. The modes of reflected light include space distribution mode in which light vectors are more orientated or nearly parallel and intensity distribution mode, of reflected light on illuminated surface, in which intensity is nearly even on illuminated surface; Both types of modes can co-exist in a illuminator. The illuminator of the present invention can be applied to display of mobile phone, personal digital assistant PDA, and notebook computer, backlight module, and general illuminating usage.

### BACKGROUND OF THE INVENTION

1. Field of the Invention

The present invention of illuminator pertains to converting spot light source, especially light-emitting-diode, into planar light source with some kind of intensity distribution mode, including one or a plurality of spot light sources and one or a plurality of reflectors, characterized in that spot light sources are located at nook positions, and the reflectors can be designed elastically according to requirement of modes of reflected light vector distribution in space and modes of reflected light intensity distribution on illuminated surface. The illuminator of the present invention can be applied to display of mobile phone, personal digital assistant PDA, and notebook computer, backlight module, and general illuminating usage.

2. Description of Related Art

It is CCFT cold cathode fluorescent tube that is generally adopted as light source for backlight module of mobile phone, personal digital assistant PDA, and notebook computer. As CCFT has problems of pollution and electricity consumption, there is a trend that LED light-emitting-diode is replacing CCFT.

Although LED's usage is prevailing more and more in liquid crystal display and illuminating device, there are still some problems, resulting from spot-type light source of LED, to be overcome, such as 1. higher cost to convert spot light source into planar one, 2. weaker illumination in positions between major illuminated field of each two spot light sources, 3. difficulty of heat dissipation when LED uses higher voltage to get higher brightness, 4. lacking of directivity when LED provides light for light-entering surface of light guide plate LGP, which makes LGP design difficult. Accordingly, it is important to convert spot-type light source of LED into planar one which has higher evenness, better directivity, better heat dissipation, higher energy efficiency and less LED.

As illustrated in FIG. 1 energy distribution pattern of one LED having Gaussian function distribution, which is used often, LED has different intensity at different angles. The transverse coordinate represents angle formed by one direction ray and central line of LED illuminated field; longitudinal coordinate represents relative intensity of corresponding angle, and the highest intensity is made unit. As it is of Gaussian function, central position has the highest intensity, and intensity is getting lower away from central line.

As illustrated in FIG. 2 light source made of several LEDs having Gaussian function distribution, wherein
L=2*d*tan(θ1)
θ1: angle of illuminated field of LED
d: distance between LED and LGP
P: distance between each two neighboring LED
L: effective range of illumination
E: region of low brightness
θc: critical angle

As effective range of illumination L is proportional to distance between LED and LGP d, it is necessary for increasing effective range of illumination L to enlarge distance between LED and LGP d. That will make occupied space increase. Another way to increasing effective range of illumination L is to shorten distance between each two neighboring LED P, but this will make LED quantity increase. Besides, as those LEDs are of Gaussian function, brightness is highest at center of effective range of illumination L, and lowest in region of low brightness E, and brightness unevenness happens on entering surface of LGP.

As illustrated in FIG. 3 energy distribution pattern of three LEDs having Gaussian function distribution, The transverse coordinate represents position along a transverse line of LGP's entering surface; longitudinal coordinate represents relative intensity of corresponding position, and the highest intensity is made unit. As LED is spot-type light source, there are region of low brightness, unevenness of energy distribution, and therefore dark shadows on display.

### SUMMARY OF THE INVENTION

The present invention is to solve problems of conventional designs converting LED spot light source into planar light source, such as needing more LED, unevenness of illumination, heat dissipating difficulty when using higher voltage, and difficulty of backlight module design resulting from lacking directivity of light, and to provide planar light source having higher evenness and directivity, higher energy efficiency, better heat dissipation and using less LED.

The first aim of the present invention is to design reflector of illuminator which has light source located at nook position, and has energy and vector distribution modes to match different needs of illuminators, including every kind of assemblages of evenness, directivity of light and occupied space of illuminator.

The second aim is to provide reflector which has higher energy efficiency by controlling light energy and vector distribution.

Another aim of the present invention is to provide reflector which has higher heat-dissipating ability or can endure higher temperature.

The manufacturing processes of the present invention's illuminator include: designing reflectors, fabricating mold of reflectors, manufacturing reflectors, and assembling as illustrated in FIG. 15.

The reflector's geometrical design is to be the major part of the present invention, but the field of the present invention is not limited to reflector's geometrical design only.

According to the foci of the present invention's technical thought—“spot light source is located at nook position, and reflector can be designed elastically according to requirement of mode of reflected light vector distribution in space and mode of reflected light intensity distribution on illuminated surface.”—the present invention provides several kinds of illuminators having reflectors wherefrom reflected light is evenly distributed or highly orientated or compromise of both.

Referring to illustrations, several vector and intensity distribution modes, which are set as destinations of designing reflectors, are demonstrated as follows.

As illustrated in FIG. 4 vector mode of one of desired modes of reflected light, cube abcdefg is an imaginary frame for convenience of showing vector distribution in space, and surface abcd is light-entering face of light guide plate LGP. The spot light source is situated at nook position of reflector; the spot light source and reflector are outside surface efgh and not shown in FIG. 4. Reflected light is emitted from line segment fg by reflector. The reflected light's intensity on illuminated surface abcd is evenly distributed. As eyes look along x-axis, reflected light vectors are parallel or nearly parallel distributed like vectors on surface bcgf. Vectors on surface bcgf shown in FIG. 4 are parallel or nearly parallel to y-axis, however the present invention does not limit those said vectors parallel to y-axis only, but includes those vectors parallel to directions having an angle with respect to y-axis. As eyes look along z-axis, reflected light vectors are distributed in sector-like expansion from reflector, like vectors on surface abfe. In FIG. 4, each arrow of vector does not represent equal energy, and those arrows are used to indicate directions of vector only.

As illustrated in FIG. 5 vector mode of another one desired reflected light's modes, cube abcdefg is an imaginary frame for convenience of showing vector distribution in space, and surface abcd is light-entering face of light guide plate LGP. The spot light source is situated at nook position of reflector; the spot light source and reflector are outside surface efgh and not shown in FIG. 5. Reflected light is emitted by reflector situated outside surface efgh. Also in FIG. 5, each arrow of vector does not represent equal energy, and those arrows are used to indicate directions of vector only. The reflected light's intensity distribution on illuminated surface abcd in FIG. 5 is not cared because the aim of FIG. 5 mode is to achieve a parallel vector distribution. As eyes look along x-axis, reflected light vectors are parallel or nearly parallel distributed like vectors on surface bcgf. Vectors on surface bcgf shown in FIG. 5 are parallel or nearly parallel to y-axis, however the present invention does not limit those said vectors parallel to y-axis only, but includes those vectors parallel to directions having an angle with respect to y-axis. As eyes look along z-axis, reflected light vectors are also parallel or nearly parallel distributed, like vectors on surface abfe.

As illustrated in FIG. 6 vector mode of further one desired reflected light's modes, cube abcdefg is an imaginary frame for convenience of showing vector distribution in space, and surface abcd is light-entering face of light guide plate LGP. The spot light source is situated at nook position of reflector; the spot light source and reflector are outside surface efgh and not shown in FIG. 6. Reflected light is emitted by reflector which is situated outside surface efgh. Also in FIG. 6, each arrow of vector does not represent equal energy, and those arrows are used to indicate directions of vector only. The reflected light's intensity distribution on illuminated surface abcd in FIG. 6 is compromised between highly even intensity distribution in FIG. 4 and uneven intensity distribution in FIG. 5. The vector distribution mode in FIG. 6 having pretty evenness and orientation is a compromise between FIG. 4 and FIG. 5. As eyes look along x-axis, reflected light vectors are parallel or nearly parallel distributed like vectors on surface bcgf. Vectors on surface bcgf shown in FIG. 6 are parallel or nearly parallel to y-axis, however the present invention does not limit those said vectors parallel to y-axis only, but includes those vectors parallel to directions having an angle with respect to y-axis. As eyes look along z-axis, reflected light vectors distribution are compromised between fan-like distribution in FIG. 4 and parallel distribution in FIG. 5.

Brief Description of Reflectors' Designing

The First Mode Reflector (Having Reflected Light's Distribution in FIG. 4)

Referring to FIG. 7, cube lmnpqrst is an imaginary frame for convenience of showing reflector ABCD; BD and AC can be curve (solid line) or straight line (dotted line), and the said designing is described in brief as follows:
Determining position of light source, which is located at nook position of reflector ABCD;
Determining latitudinal center curve EF of reflector ABCD which makes light's energy reflected from EF evenly distributed on latitudinal center line u′v′ of light-entering face uvgh;
Determining longitudinal curves or straight lines of reflector ABCD such as BD [symbol] B′D′ and B″D″ which make reflected light's vectors parallel to a given orientation, such as Y-axis;
Determining reflector ABCD by combining latitudinal center line EF and a plurality of longitudinal curves or straight lines such as BD [symbol] B′D′ and B″D″.
   The Second Mode Reflector (Having Reflected Light's Distribution in FIG. 5)

Referring to FIG. 11, cube lmnpqrst is an imaginary frame for convenience of showing reflector AEBDFC; BD, EF and AC can be curve (solid line) or straight line (dotted line), and the said designing is described in brief as follows:
determining position of light sources, which is located at nook positions of reflector AEBDFC;
determining latitudinal center curves HJ and JK of reflector AEBDFC which makes light's vectors reflected from HJ and JK vertical to latitudinal center line l′m′ of light-entering face lmnp, with each of curves HJ and JK being part of a parabolic whereof focus is at nearby of lp or mn i.e. nook positions of LGP7's light-entering face lmnp, and with light sources positioned at said foci;
determining longitudinal curves or straight lines of reflector AEBD FC such as AC, BD and EF which make reflected light's vectors parallel to a given orientation, such as Y-axis;
determining reflector AEBDFC by combining latitudinal center line EF and a plurality of longitudinal curves or straight lines such as AC, BD and EF.
   The Third Mode Reflector (Having Reflected Light's Distribution in FIG. 6)

The third mode reflectors are similar to that of the second mode illustrated in FIG. 11, but relative positions of light sources to reflector are different from that of the second mode. The light source position of the third mode is more close to reflector than the second mode, and this makes different light distribution having appreciable energy evenness and vector orientation.

Adjusting the united architecture of light source and reflector by rotation or translation can change the parallel reflected light mentioned-above to parallel other orientations.

Detailed Description of Reflectors' Designing

The reflector's design will be further described in detail as follows.

The First Mode Reflector

Referring to FIG. 7 and FIG. 8, the design of the first mode reflector is described further as follows:
A. Latitudinal center curve EF of reflector ABCD in FIG. 7 is determined, which makes light's energy reflected from EF evenly distributed on latitudinal center line u′v′ of light-entering face uvgh, by means of finite elements method, according to reflective law of optics.
   The steps include:
   (1) dividing light source (such as LED in FIG. 8) energy by angle into N equal-energy elements, as illustrated in FIG. 8, wherein N is a natural number; or as illustrated in FIG. 9, “dividing light energy on X-Y plane of Rod Lens into N equal-energy elements” taking the place of that aforementioned, when LED packaged inside Rod Lens, wherefrom light is emitted in sector-like form on X-Y plane;
   (2) dividing latitudinal center line u′v′ of light-entering face 8 of LGP 7 into N equal-length elements;
   (3) matching each of said N equal-energy elements with corresponding one of said N equal-length elements according to a certain rule;
   (4) determining light source position;
   (5) determining the initial reflecting point of curve EF from the first emitted ray associated with the first equal-energy element;
   (6) determining the first emitting optical path by connecting light source position with the initial reflecting point of curve EF;
   (7) determining the first reflected optical path by connecting the initial reflecting point of curve EF with the first equal-length element determined by said matching in (3);
   (8) determining the first normal (at the initial reflecting point) of curve EF from bisector of the angle formed by said the first emitting optical path and said the first reflected optical path, according to reflective law;
   (9) determining the first tangential (at the initial reflecting point) from said the first normal;
   (10) determining the second reflecting point from intersecting point of the first tangential and the second emitted ray associated with the second equal-energy element;
   (11) determining the second emitting optical path by connecting light source position with the second reflecting point of curve EF;
   (12) determining the second reflected optical path by connecting the second reflecting point with the second equal-length element determined by said matching in (3);
   (13) determining the second normal (at the second reflecting point) of curve EF from bisector of the angle formed by the second emitting optical path and the second reflected optical path, according to reflective law;
   (14) determining the second tangential (at the second reflecting point) from the second normal;
   (15) repeating step (10) to (14) until said equal-energy elements and equal-length elements are exhausted.

Once finishing step (15), N reflecting points of latitudinal center curve EF are determined, and thus curve EF is determined also, which makes light's energy reflected from EF evenly distributed on latitudinal center line u′v′.
B. When light source is LED, longitudinal curves of reflector ABCD is determined, which make reflected light's vectors parallel to a given orientation. As the assembly of vectors emitted from spot light source LED is cone-like, the parabolic is needed to achieve parallel reflected light vectors.
   The steps include:
   (1) connecting each reflecting point of curve EF with light source to form N line segments;
   (2) producing N parabolas, with each reflecting point of curve EF being vertex, each corresponding line segment being focal length, and spot light source being common focus;
   (3) sectioning each said parabola with extended planes of LGP7's light-outputting surface hiuv of LGP and its opposite surface kjgh in FIG. 7 to produce N parabolas' segments, each of which make reflected light's vectors parallel to a given orientation, such as Y-axis direction.
C. When LED is packaged inside Rod Lens as in FIG. 9, longitudinal curves of reflector ABCD is determined, which make reflected light's vectors parallel to a given orientation. The X-Y-Z orientation in FIG. 7 is the same as X-Y-Z orientation in FIG. 9, and Rod Lens is set in such a way that the transverse symmetry plane hijk of Rod Lens, shown in part 1 of FIG. 9, parallels light-outputting surface hiuv in FIG. 7 i.e. parallels X-Y plane. As illustrated in part 2 of FIG. 9, when eyes look along X-axis direction, light vectors emitted from Rod Lens are parallel. There is no need of longitudinal curved lines to transform multi-directioned emitted light into parallel reflected vectors, since emitted light itself is parallel in such way, so longitudinal curves of reflector ABCD in this case are straight lines i.e. dotted lines in FIG. 7.
   The steps include:
   (1) determining N straight lines vertical to X-Y plane and intersecting N reflecting points of latitudinal center curve EF separately;

(2) sectioning each of said straight lines with extended planes of LGP7's light-outputting surface hiuv and its opposite surface kjgh in FIG. 7 to produce N lines' segments, each of which make reflected light's vectors parallel to a given orientation, such as Y-axis direction.
D. By combining latitudinal center curve EF and longitudinal curve segments or longitudinal line segments of reflector ABCD, the first mode reflector ABCD in FIG. 7, which has evenly distributed energy on light-entering face, is completed.

As illustrated in FIG. 21, according to process B, the closer the reflecting point on EF to light source, the shorter the distance between reflecting point and light source, and the shorter the focal length; thus width of reflector neighboring light source may be less than width of vertical side of LGP's light-entering face. In this case, “parabola with light source not at its focus” will takes the place of “parabola with light source at its focus” in the local portion wherein width of reflector is shorter than width of vertical side of LGP's light-entering face, if according to process B.

Adjusting the united architecture of light source and reflector by rotation or translation can change the parallel reflected light vectors mentioned-above to parallel other orientations.

The Second Mode Reflector

As illustrated in part 1 of FIG. 10, the reflected light vectors, which is emitted from focus, parallel symmetry axix X-Y of parabolic reflector abcd. When light (such as from LED) emitted from focus is limited to a given angle range such as sector-like portion Fcd, and only partial reflector such as cd is illuminated, the light vectors reflected by cd parallel symmetry axis X-Y yet, even though symmetry axis X-Y is not in center of illuminated field Fcd of emitted light, nor is in center of reflecting area cd, but in nook part of illuminated field Fcd and reflecting area cd; moreover spot light source is not among illuminated field ghdc of reflected light.

The aforementioned reflector of partial parabola is characterized in that 1. spot light source is at nook position of reflector; 2. spot light source is not among illuminated field of reflected light; 3. reflected light vectors are parallel to each other. This makes partial parabola's reflector suitable to realize the aims of the present invention—to transform spot light source which is at nook position of reflector into planar light source having some kind of intensity and vector distribution mode.

As illustrated in part 2 of FIG. 10, after rotating partial parabola's reflectors ab and cd vertically and horizontally and placing spot light sources at foci, the reflected light vectors parallel symmetry axis. If the symmetry axis is made to parallel Y-axis in FIG. 5 or FIG. 11, the parabolic segments dc and ba can be used as curve HJK in FIG. 11 to produce distribution mode of reflected light illustrated in FIG. 5.

Light source of the second mode reflector includes LED and Rod-Lens-encapsulating LED, which are located at nook positions of reflectors and light-entering face of LGP.

As illustrated in FIG. 12 and FIG. 13, when reflector is parabola's segment or, p is its focus, and o vertex, line po symmetry axis, line segment pq light-entering face having length of L, r middle point of pq, line segment po the largest distance from reflector or to light-entering face pq; line pr is vertical to symmetry axis po, and passes through focus p, and intersects parabola's segment or in r.

Parabola's segment or covers line segment pr; pr is reflector or's projection on light-entering face pq, and line segment pr's length W equals half of light-entering face pq's length L, i.e. W=½L. In this case, po—the largest distance from reflector or to light-entering face pq equals focal length f.

As illustrated Part1 and Part2 in FIG. 13, to get relationship between f and L, (f,w)=(f,L/2) is substituted into parabola's equation B²=4fA, and f=L/4 is got. It means that in the second mode reflector wherein reflected light vectors are parallel to each other and vertical to light-entering face of LGP, focal length equals one-fourth of light-entering face's length i.e. h=f=L/4 wherein h is the largest distance from reflector or to light-entering face, in the case of FIG. 13, light-entering face lies on line pr.

To describe design of the second mode reflector in detail, two coordinate systems are defined as follows.

One of coordinate systems takes longer side of light-entering face of LGP as X-axis, direction vertical to light-entering face of LGP as Y-axis, and shorter side of light-entering face 8 of LGP 7 as Z-axis. The other of coordinate systems takes A-axis as transversal axis, B-axis as longitudinal axis. Both coordinate systems have the same length unit.

Referring to FIG. 11, the design of the second mode reflector is described further as follows
A. Latitudinal center curves HJ and JK of reflector AEBDFC in FIG. 11 is determined, which makes light's vectors reflected from HJ and JK vertical to latitudinal center line l′m′ of light-entering face 8 lmnp.
   The steps include:

sectioning segment of parabolic curve described by equation B²=4(L/4)A as latitudinal center curves HJ and JK of reflector AEBDFC in FIG. 11, with length of HJ's and JK's projections on “line vertical to symmetry axis” being L/2; (In FIG. 12, “line vertical to symmetry axis” is line pr or rq, and in FIG. 13, “line vertical to symmetry axis” is B-axis i.e. line defined by equation A=0; and in this case, L/2—length of segment of parabolic curve's projections on “line vertical to symmetry axis” starts from B-axis i.e. line defined by equation B=0.)
B. When light source is LED, longitudinal curves of reflector AEBDFC is determined, which make reflected light's vectors parallel to a given orientation. As the assembly of vectors emitted from spot light source LED is cone-like, the parabolic is needed to achieve parallel reflected light vectors.
   The steps include:
   (1) connecting a plurality of reflecting points of latitudinal center curves HJ and JK with light source to form a plurality of line segments;
   (2) producing a plurality of parabolas, with each said reflecting point of curves HJ and JK being vertex, each corresponding line segment being focal length, and spot light source being common focus;
   (3) sectioning each produced parabola with extended planes of LGP7's light-outputting surface 8 uvml of LGP 7 and its opposite surface ownp in FIG. 11 to produce a plurality of parabolas' segments, such as parabolas' segments AC, EF and BD (solid line segment) in FIG. 11, each of which make reflected light's vectors parallel to a given orientation, such as Y-axis direction.
C. When light source is Rod-Lens-packaged LED as in FIG. 9, longitudinal curves of reflector AEBDFC is determined, which make reflected light's vectors parallel to a given orientation. The X-Y-Z orientation in FIG. 11 is the same as X-Y-Z orientation in FIG. 9, and Rod Lens is set in such a way that the transverse symmetry plane hijk of Rod Lens, shown in part 1 of FIG. 9, parallels light-outputting surface uvml in FIG. 11 i.e. parallels X-Y plane. As illustrated in part 2 of FIG. 9, when eyes look along X-axis direction, light vectors emitted from Rod Lens are parallel. There is no need of longitudinal curved lines to transform multi-directioned emitted light into parallel reflected vectors, since emitted light itself is parallel in such way, so longitudinal curves of reflector AEBDFC in this case are straight lines i.e. dotted lines in FIG. 11.
   The steps include:
   (1) determining a plurality of straight lines vertical to X-Y plane and intersecting a plurality of reflecting points of latitudinal center curves HJ and JK separately;
   (2) sectioning each said straight lines with extended planes of LGP7's light-outputting surface uvml and its opposite surface ownp in FIG. 11 to produce a plurality of lines' segments, such as AC [symbol] EF and BD (dotted line), each of which make reflected light's vectors parallel to a given orientation, such as Y-axis direction.
D. By combining latitudinal center curves HJ and JK and longitudinal curve segments or longitudinal line segments of reflector AEBDFC, the second mode reflector AEBDFC in FIG. 11, which has highly orientated reflected light vectors, is completed.

As illustrated in FIG. 21, according to process B, the closer to light source, the shorter the distance between reflecting point and light source, and the shorter the focal length; thus width of reflector neighboring light source may be less than width of vertical side of LGP's light-entering face. In this case, “parabola with light source not at its focus” will take the place of “parabola with light source at its focus” in the local portion wherein width of reflector is shorter than width of vertical side of LGP's light-entering face, if according to process B.

Adjusting the united architecture of light source and reflector by rotation or translation can change the parallel reflected light vectors mentioned-above to parallel other orientations.

The Third Mode Reflector

To achieve reflector having appreciable evenness of energy distribution and appreciable orientation of vector distribution of reflected light as illustrated in FIG. 6, design of the third mode reflector is described as follows.
(1) placing LED or Rod-Lens-packaged LED at nook position of light-entering face of LGP;
(2) sectioning a parabolic segment from parabola defined by equation B²=4fA=4(nL/4)A, with length of said parabolic segment's projection on “line vertical to symmetry axis” being W=L/2 and n being positive real number;
(3) setting measuring of projection's length W=L/2 start from line defined by B=k, wherein k is real number, and larger than (−L/4);
(4) making the end of reflector, which is far away from vertex of said parabolic curve, contact light-entering face;

The maximal distance between reflector and light-entering face “h” depends upon length of sectioned parabolic segment's projection on symmetry axis. The magnitude of h has close relation with the space occupied by illuminator, and therefore the space occupied by backlight module.

As illustrated in part 1 and part 2 of FIG. 14, c1 is the parabola defined by equation Y²=4(L/4)X, and c2 is the parabola defined by Y²=4(nL/4)X. Sectioning a parabolic segment from said parabola c2, with length of said parabolic segment's projection on “line vertical to symmetry axis Y=0” being W=L/2 and n being positive real number, two ends of said parabolic segment are:

Coordinate of end A far away from vertex: (x1,y1),

Coordinate of end B more close to vertex: (x2,y2).

When measuring of projection's length W=L/2 starts from symmetry axis Y=0, A(x1,y1)=(L/4n,L/2), and B(x2,y2)=(0,0).

When measuring of projection's length W=L/2 does not start from symmetry axis Y=0, but starts from straight line Y=k,
A(x1,y1)=(x1,L/2+k), and
B(x2,y2)=(x2,k).

From equation Y²=4(nL/4)X,
x1=L/4n+k/n+k²/nL, and
x2=k²/nL.

The maximal distance between reflector and light-entering face “h” i.e. length of sectioned parabolic segment's projection on symmetry axis is to be that h=|x1−x2|=|L/4n+k/n|.

As the magnitude of h has close relation with space occupied by backlight module, it seems that the less of h, the better; however space occupied by backlight module is not the only one factor taken into consideration, energy evenness, vector orientation of reflected light and space for light source are also factors taken into consideration when choosing h, and thus n which relates to h in that h=|L/4n+k/n|.

The third mode reflectors are similar to that of the second mode illustrated in FIG. 11, but the light source position of the third mode is more close to reflector than the second mode.

Referring to FIG. 11, to achieve the third mode reflector having energy and vector distribution of reflected light illustrated in FIG. 6, the illuminator includes two light sources (not shown in FIG. 7) and two reflectors, with two reflectors being symmetric to each other, and each reflector having one light source which is located at nook position of reflector. The said light source is Rod Lens packaged LED.

To describe design of the third mode reflector in detail, two coordinate systems are defined as follows.

Referring to FIG. 11, one of coordinate systems takes longer side of light-entering face lmnp of LGP 7 as X-axis, direction vertical to light-entering face lmnp of LGP 7 as Y-axis, and shorter side of light-entering face lmnp of LGP 7 as Z-axis. The other of coordinate systems takes A-axis as transversal axis, B-axis as longitudinal axis. Both coordinate systems have the same length unit.

The X-Y-Z orientation in this case is the same as X-Y-Z orientation in FIG. 9, and Rod Lens is set in such a way that the transverse symmetry plane hijk of Rod Lens, shown in part 1 of FIG. 9, parallels light-outputting surface lmnp of LGP 7 in FIG. 11 i.e. parallels X-Y plane. As illustrated in part 2 of FIG. 9, when eyes look along X-axis direction, light vectors emitted from Rod Lens are parallel. There is no need of longitudinal curved lines of reflector to transform multi-directioned emitted light into parallel reflected vectors, since emitted light itself is parallel in such way, so longitudinal curves of reflector in this case are straight lines.

The design steps of the third mode reflector include:

(1) sectioning a parabolic segment, as latitudinal center curve of reflector, from parabola defined by equation B²=4fA=4(nL/4)A, with L being length of longer side of light-entering face, length of said parabolic segment's projection on “line vertical to symmetry axis” being W=L/2 and n being positive real number;

(2) setting measuring of projection's length W=L/2 start from line defined by B=k, wherein k is real number, and larger than (−L/4);

(3) making the end of said parabolic segment, such as J point in FIG. 11, which is far away from vertex of said parabolic curve, contact light-entering face, such as lmnp in FIG. 11;

(4) determining a plurality of straight lines, as longitudinal curve of reflector, vertical to X-Y plane and intersecting a plurality of reflecting points of said parabolic segment, such as HJ or JK in FIG. 11, separately;

(5) sectioning each of said straight lines with extended planes of LGP7's light-outputting surface, such as uvml in FIG. 11 and its opposite surface, such as ownp in FIG. 11, to produce a plurality of lines' segments, such as AC, EF, and BD (dotted lines) in FIG. 11, each of which make reflected light's vectors parallel to a given orientation, such as Y-axis direction.

(6) combining latitudinal center curve, such as HJ or JK in FIG. 11 and longitudinal line segments, such as AC, EF, and BD in FIG. 11.

Then, the third mode reflector, which has appreciable energy evenness and vector orientation, such as AEFC or EBDF in FIG. 11, is completed.

The fact that light emitted from Rod Lens is parallel just occurs in ideal condition. Owing to need of decreasing thickness of Rod Lens, it is possible for spot light source LED to be placed at positions which are not the most suitable to emit parallel light. After LED light passes through fluorescent material, which has a given area, light source becomes non-spot light source. Because of the reasons mentioned above, light emitted from Rod Lens may not be parallel completely, and has a certain open angle. To reduce said open angle, reflecting plates are equipped on both lateral sides of Rod Lens to make dispersed light more concentrated, as illustrated in part 1 and part 2 in FIG. 16. Equipping Rod Lens with reflecting plates is also one of the technical means to achieve aims of the present invention—planar light source having better energy evenness, vector orientation and higher energy efficiency, thus equipping Rod Lens with reflecting plates is also included in the scope of the present invention.

Reflector made of ceramics or metals of high thermal conductivity can tolerate higher temperature and has better heat-dissipating ability, so larger size LED can be adopted to get higher brightness and reduce LED number; therefore reflector made of ceramics or metals of high thermal conductivity is also one of the technical means to achieve another aim of the present invention—reducing LED number, thus reflector made of ceramics or metals of high thermal conductivity is also included in the scope of the present invention.

Reflector can also has better heat-dissipating ability by making both sides of reflector contact air directly, therefore making both sides of reflector contact air directly is also one of the technical means to achieve another one of the present invention's aim—reducing LED number, thus making both sides of reflector contact air directly is also included in the scope of the present invention.

In addition to reducing power consumption by reducing LED number, the present invention can also reduce power consumption by controlling light orientation.

As illustrated in part 1 of FIG. 17, in the conventional backlight module, light enters LGP in random direction and without any certain orientation, wherein θ_{c} is the critical angle of LGP's material, and θ is the angle range inside which light will proceed to the reach of opposite face A of light-entering face, and θ₁ is the angle of any given light beam inside said angle range; the angles mentioned above are all measured from horizontal line. From part 1 of FIG. 17, θ₁≦θ, and θ<θ_{c}, so θ₁<θ_{c}; therefore light within said angle range will transmit through face A, and light within angle range of 2θ will be lost.

If the light's angle is controlled to be larger than θ=tan⁻¹t/S, there will be no light lose from face A, and then power consumption will be reduced, therefore controlling light orientation is also one of the technical means to achieve one of the present invention's aims—reducing power consumption, thus controlling light orientation is also included in the scope of the present invention.

### BRIEF DESCRIPTION OF THE DRAWINGS

FIG. 1 illustrates energy distribution of single LED.

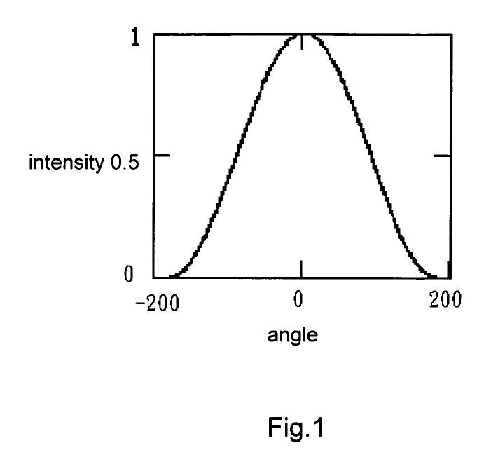

FIG. 2 illustrates the illuminated field of a plurality of LEDs and corresponding parameters.

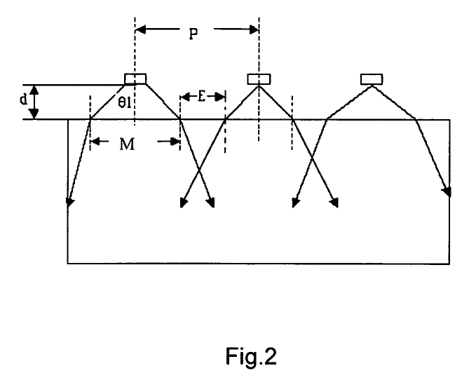

FIG. 3 illustrates intensity distribution mode of three conventional LEDs.

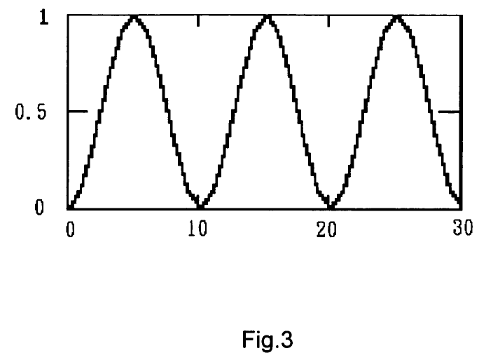

FIG. 4 illustrates vector distribution of the first mode reflector of the present invention.

FIG. 5 illustrates vector distribution of the second mode reflector of the present invention.

FIG. 6 illustrates vector distribution of the third mode reflector of the present invention.

FIG. 7 illustrates design of the first mode reflector of the present invention.

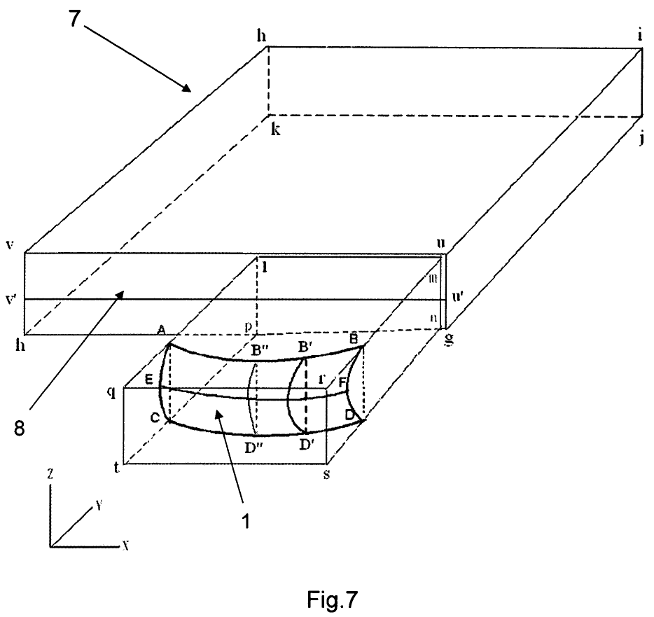

FIG. 8 illustrates finite elements' division and matching of LED's energy and light-entering face.

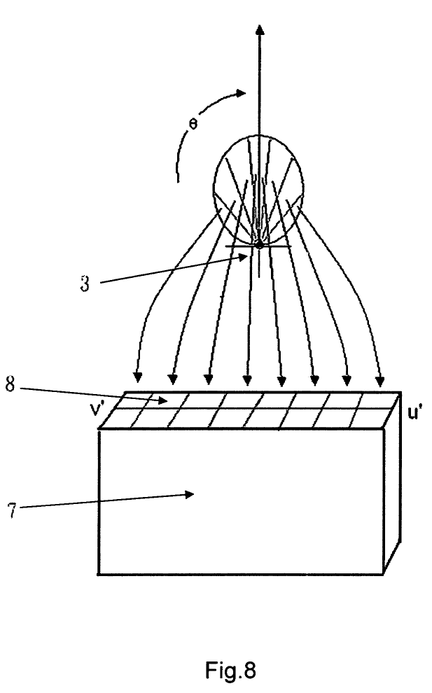

FIG. 9 illustrates Rod Lens packaged LED.

FIG. 10 illustrates reflector formed by partial parabolic curve.

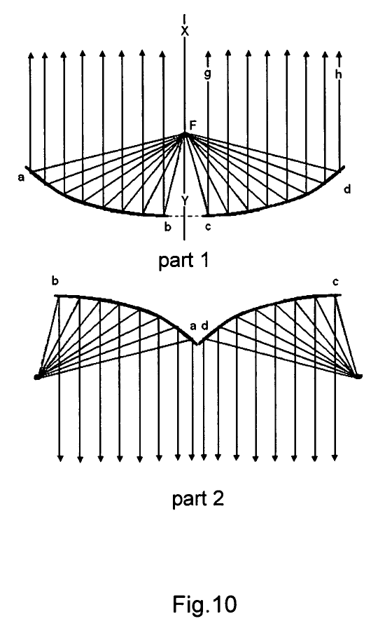

FIG. 11 illustrates design of the second mode reflector of the present invention.

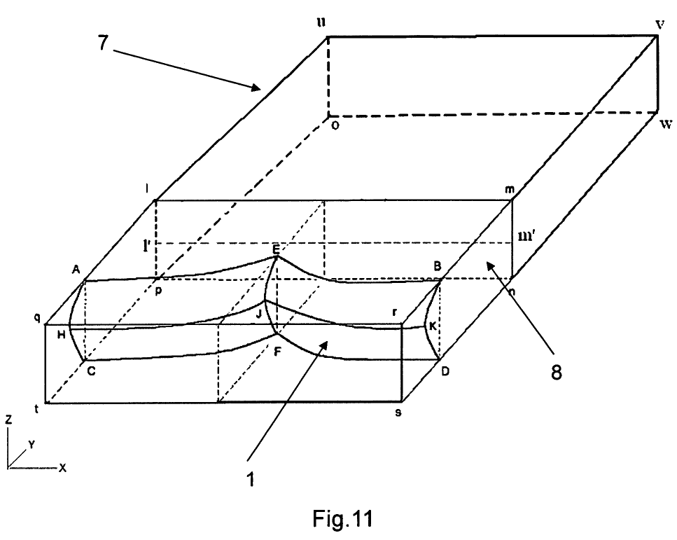

FIG. 12 illustrates corresponding parameters of partial parabola's reflector of the present invention.

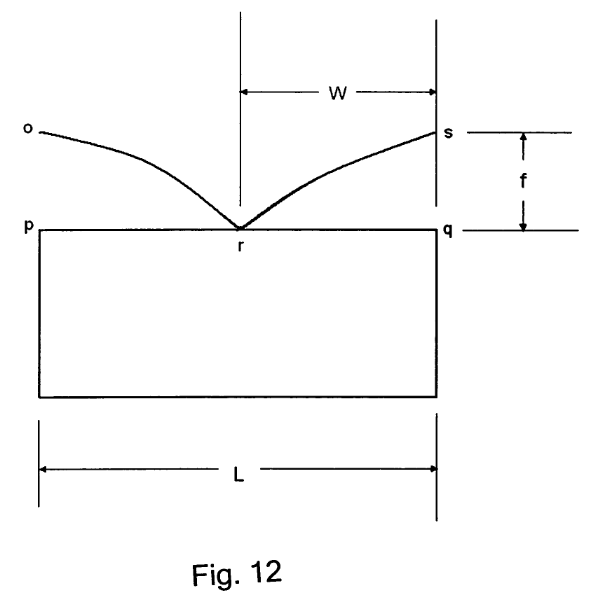

FIG. 13 illustrates also corresponding parameters of partial parabola's reflector of the present invention.

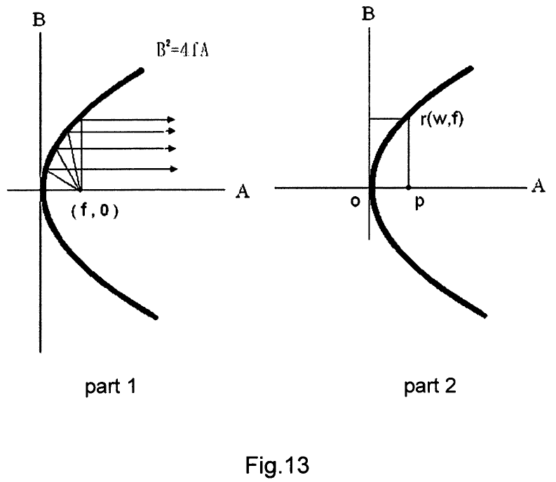

FIG. 14 illustrates design of the third mode reflector of the present invention.

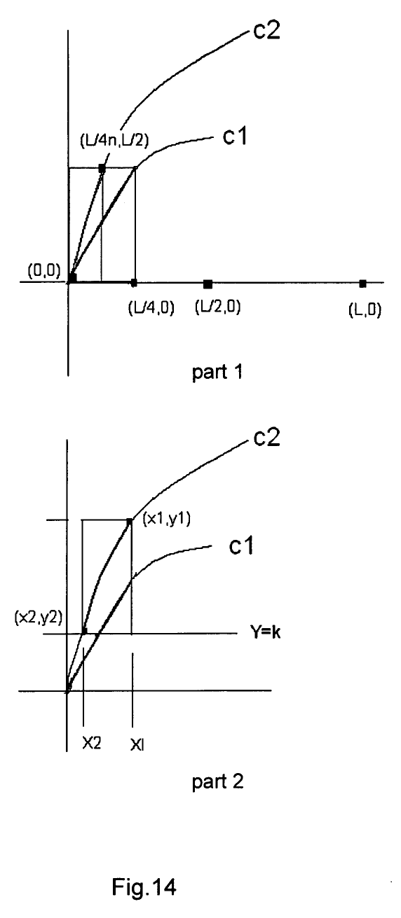

FIG. 15 illustrates assembling processes of illuminator of the present invention.

FIG. 16 illustrates Rod Lens equipped with reflecting plates.

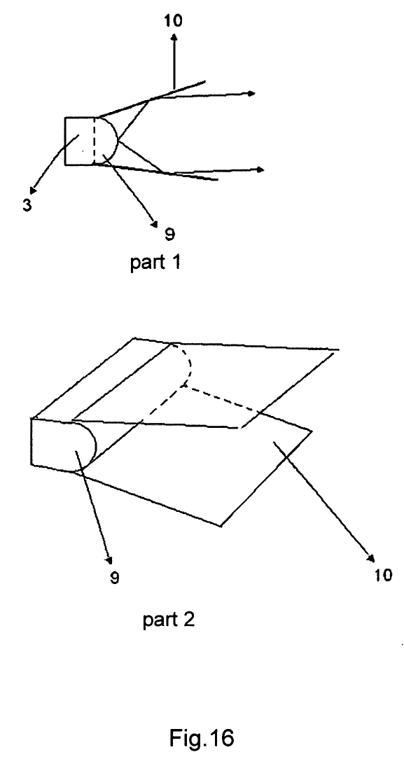

FIG. 17 illustrates avoiding energy waste of the present invention by controlling light orientation.

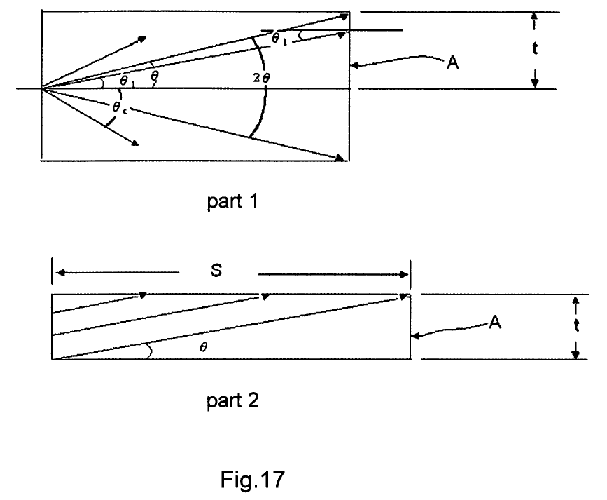

FIG. 18 illustrates the first preferred embodiment of the present invention.

FIG. 19 illustrates three-dimensional map of reflector 11 of the first preferred embodiment of the present invention.

FIG. 20 illustrates another three-dimensional map of reflector 11 of the first preferred embodiment of the present invention.

FIG. 21 illustrates the second preferred embodiment of the present invention.

FIG. 22 illustrates the first three-dimensional map of reflector 12 of the second preferred embodiment of the present invention.

FIG. 23 illustrates the second three-dimensional map of reflector 12 of the second preferred embodiment of the present invention.

FIG. 24 illustrates the third three-dimensional map of reflector 12 of the second preferred embodiment of the present invention.

FIG. 25 illustrates common image of reflectors from the third preferred to the sixth preferred embodiments of the present invention.

FIG. 26 illustrates the design of reflectors from the third preferred to the sixth preferred embodiments of the present invention.

FIG. 27 illustrates definitions of incident angle α and reflected angle γ1(α) of reflectors from the third preferred to the sixth preferred embodiments of the present invention.

FIG. 28 illustrates relation between incident angle and reflected angle, vector and energy distribution of the third preferred embodiments of the present invention.

FIG. 29 illustrates relation between incident angle and reflected angle, vector and energy distribution of the fourth preferred embodiments of the present invention.

FIG. 30 illustrates relation between incident angle and reflected angle, vector and energy distribution of the fifth preferred embodiments of the present invention.

FIG. 31 illustrates relation between incident angle and reflected angle, vector and energy distribution of the sixth preferred embodiments of the present invention.

### LIST OF REFERENCE NUMERALS

1 reflector
11 reflector of the first preferred embodiment
111 Z-axis direction's boundary of reflector 11
112 another Z-axis direction's boundary of reflector 11
113 X-axis direction's boundary of reflector 11
114 another X-axis direction's boundary of reflector 11
12 reflector of the second preferred embodiment
121 Z-axis direction's boundary of reflector 12
122 another Z-axis direction's boundary of reflector 12
123 X-axis direction's boundary of reflector 12
124 another X-axis direction's boundary of reflector 12
13 generic reflector of the third to the sixth preferred embodiment
14 specific reflector of generic reflector 13
15 another specific reflector of generic reflector 13
131 Z-axis direction's boundary of reflector 13
132 another Z-axis direction's boundary of reflector 13
133 the first X-axis direction's boundary of reflector 13
134 the second X-axis direction's boundary of reflector 13
135 the third X-axis direction's boundary of reflector 13
136 the fourth X-axis direction's boundary of reflector 13
2 connecting part of reflector
3 chip of LED OR Rod Lens encapsulating LED
4 wire
5 pins
6 transparent material
7 LGP light guide plate
8 light-entering face of LGP
9 Rod Lens
10 reflecting plate

### DETAILED DESCRIPTION OF PREFERRED EMBODIMENT OF THE PRESENT INVENTION

Six embodiments will be described below, however those are just the preferred embodiments, and the scope of the present invention is not limited to those preferred embodiments only.

The First Preferred Embodiment

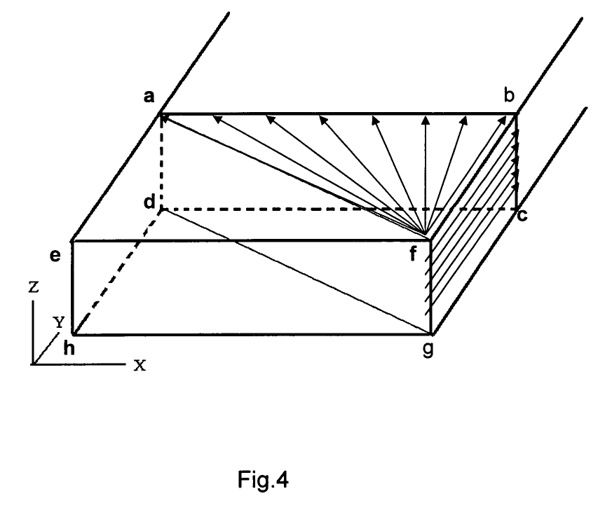

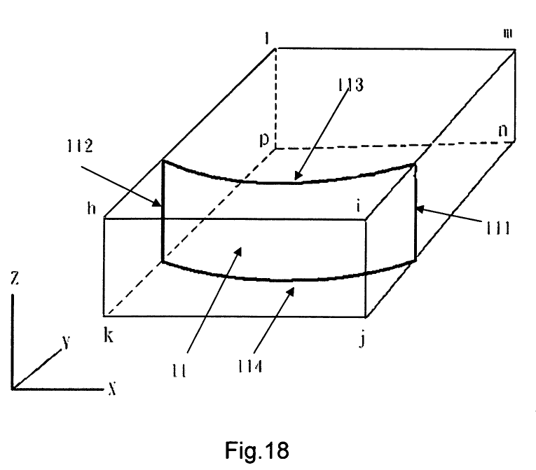

As illustrated in FIG. 18, reflector 11 of t is set inside an imaginary cube frame hijklmnp for convenience of showing it. Reflector 11 belongs to the first mode reflector mentioned above, and energy and vector distribution mode is the same as FIG. 4.

The light source of the first preferred embodiment is Rod Lens packaged LED, located at nook position of reflector 11, with transverse symmetry plane of Rod Lens parallel to light-outputting surface of LGP, and reflected light illuminates light-entering face of LGP or some portion of light-entering face of LGP.

The design of the first preferred embodiment's reflector 11 is the same as described in A, C, and D in The First mode reflector of Detailed description of reflectors' designing.

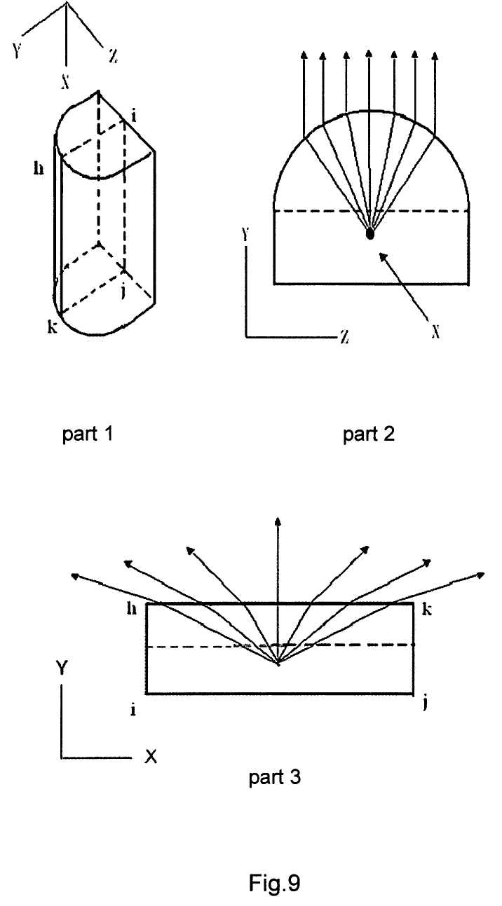

As illustrated in part 3 of FIG. 9, the light emitted from Rod Lens packaged LED present sector-like configuration. The latitudinal curves of reflector 11 is to reflect light, emitted from nook position, into light whose energy spreads evenly on illuminated face. The 3-dimensional shape of reflector 11 is an transversely inflected face, so latitudinal boundaries 113 and 114 are inflected curves.

As illustrated in part 2 of FIG. 9, according to Rod Lens' orientation mentioned above, Rod Lens packaged LED emits light which is parallel Y-axis-direction-wise, therefore it is not necessary for reflector 11 to utilize the longitudinally inflected curve along Z-axis-direction to get Y-axis-direction parallel reflected light, since straight line can reflect light, which parallel each other and have zero incident angle, into light which parallel each other and have zero reflected angle, thus the longitudinal curves of reflector 11 are straight line, and longitudinal boundaries 111 and 112 are straight line segments.

Owing to need of decreasing thickness of Rod Lens, or LED light's passing fluorescent material, light emitted from Rod Lens may not be parallel completely, and has a certain open angle. To reduce said open angle, reflecting plates are equipped on both lateral sides of Rod Lens to make dispersed light more concentrated.

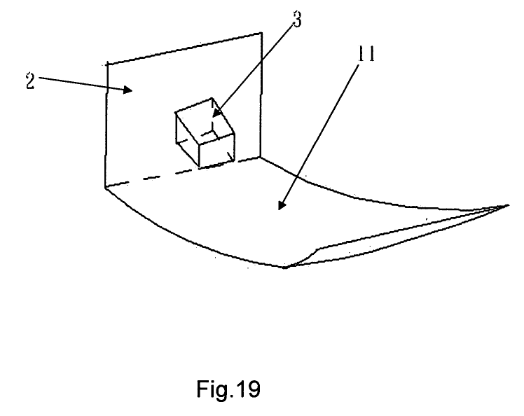

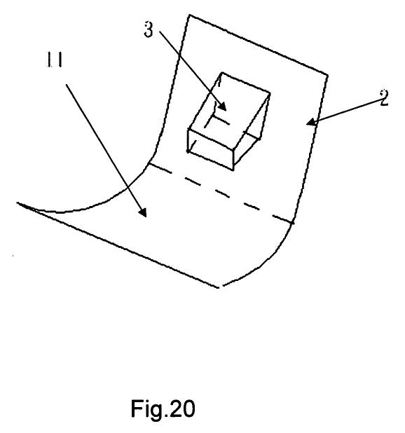

FIG. 19 and FIG. 20 illustrate 3-dimensional shape of reflector 11 viewed from different angles, wherein reflector 11 and connecting part 2 are formed into an integral unit, and Rod Lens packaged LED is set on said connecting part.

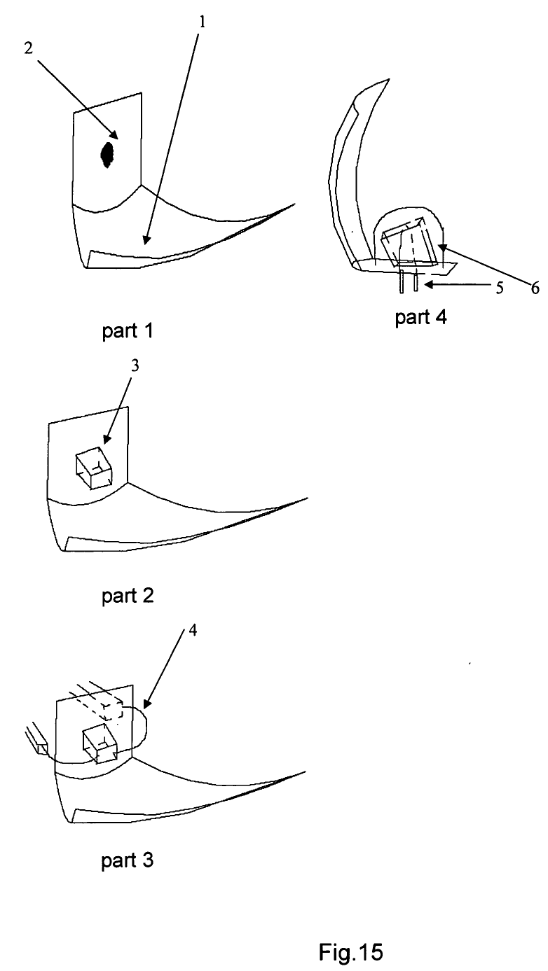

The assembling processes is illustrated in FIG. 15, including applying glue on connecting part 2 of reflector 1, as illustrated in part 1 of FIG. 15, making chip 3 of LED or Rod Lens packaged LED adhere to connecting part 2, as illustrated in part 2 of FIG. 15, connecting wire 4 with pins 5, as illustrated in part 3 of FIG. 15, and enveloping chip 3 with transparent material 6, as illustrated in part 4 of FIG. 15.

Both sides of reflector 11 contact air directly, and surface of reflector 11 is made of highly reflective materials; plate of reflector 11 is made of materials having high thermal conductivity, such as ceramic, cupric, aluminum, and ferric categories.

Adjusting the united architecture of light source 3 and reflector 11 by rotation or translation can change the parallel reflected light mentioned-above to parallel other orientations.

The Second Preferred Embodiment

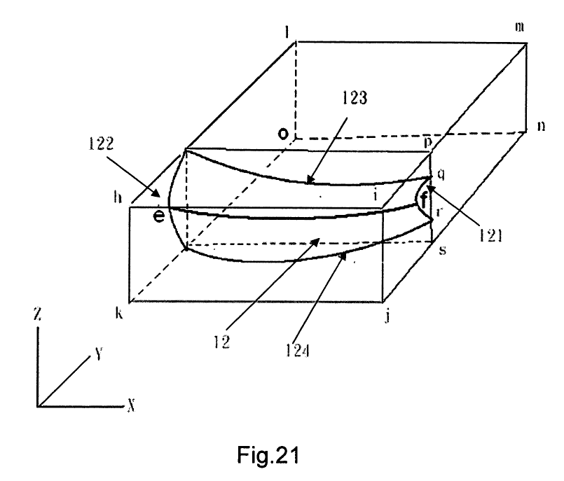

As illustrated in FIG. 21, reflector 12 of the second preferred embodiment is set inside an imaginary cube frame hijklmno for convenience of showing it. Reflector 12 also belongs to the first mode reflector mentioned above, and energy and vector distribution mode is the same as FIG. 4 too.

LED of the second preferred embodiment is not packaged inside Rod Lens, and LED is located at nook position of reflector 12, and reflected light illuminates light-entering face of LGP or some portion of light-entering face of LGP. The reflector 12's 3-dimentional shape is a surface inflected inwards from four boundaries 121, 122, 123 and 124.

The design of the second preferred embodiment's reflector 12 is the same as described in A, B, and D in The First mode reflector of Detailed description of reflectors' designing.

The latitudinal curves of reflector 12, such as ef in FIG. 21, is to reflect light, emitted from nook position, into light whose energy spreads evenly on illuminated face. Latitudinal boundaries 123 and 124 are inflected curves.

Longitudinal curves of reflector 12 is to make reflected light's vectors parallel to a given orientation. As the assembly of vectors emitted from spot light source LED is cone-like, the parabolic is needed to achieve parallel reflected light vectors.

The parabolic of longitudinal curves of reflector 12 have the LED as focus, with some points of center longitudinal curve of reflector 12, such as ef in FIG. 21, being vertexes, and distance between some given points of ef and LED being focal lengths.

As illustrated in FIG. 21, the closer the points on ef to LED, the shorter the distance between reflecting point and LED, and the shorter the focal length; thus width of reflector 12 neighboring LED, such as qr in FIG. 21, may be less than width of vertical side of LGP's light-entering face, such as ps in FIG. 21. In the case that the distance between reflector 12 and light-entering face is reasonable, i.e. that focal length is constrained by said reasonable distance, some left part of light-entering face will not be illuminated, such as pq and rs in FIG. 21. In this case, “parabola with light source not at its focus” will take the place of “parabola with light source at its focus” in the local portion wherein width of reflector 12 is shorter than width of vertical side of LGP's light-entering face.

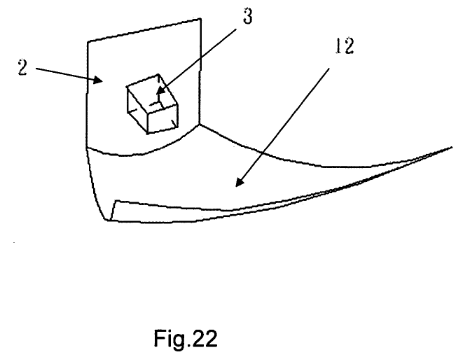

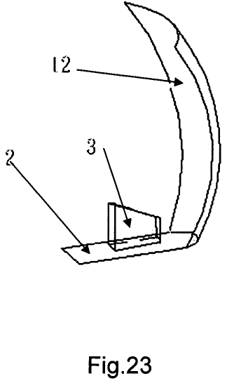

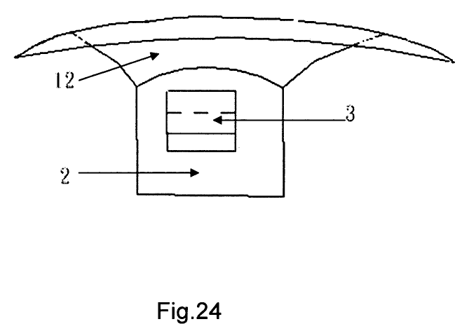

FIG. 22 to FIG. 24 illustrate 3-dimensional shapes of reflector 12 viewed from different angles, wherein reflector 12 and connecting part 2 are formed into an integral unit, and LED is set on said connecting part 2.

Both sides of reflector 12 contact air directly, and surface of reflector 12 is made of highly reflective materials; plate of reflector 12 is made of materials having high thermal conductivity, such as ceramic, cupric, aluminum, and ferric categories.

Adjusting the united architecture of light source 3 and reflector 12 by rotation or translation can change the parallel reflected light mentioned-above to parallel other orientations.

The Third to the Sixth Preferred Embodiments

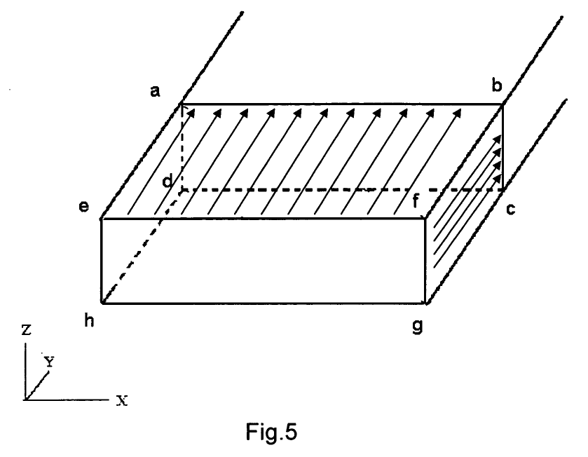

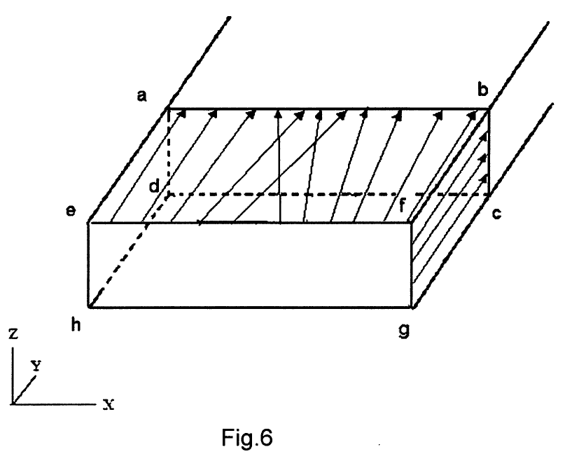

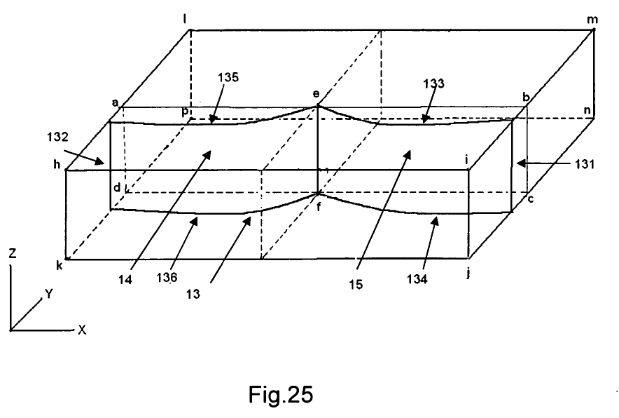

As illustrated in FIG. 25, reflector 13 of the third to the sixth preferred embodiments is set inside an imaginary cube frame hijkabcd for convenience of showing it. Reflector 13 belongs to the second or the third mode reflector mentioned above, and energy and vector distribution mode is the same as FIG. 5 or FIG. 6.

Illuminator of the third to the sixth preferred embodiments includes two light sources (not shown in FIG. 25) and a generic reflector 13 which further comprises two specific reflectors 14 and 15, with said two reflectors being symmetric to each other with respect to longitudinal center line of generic reflector 13, and each reflector having one light source which is located at nook position of reflector. The said light sources are Rod Lens packaged LEDs, located at nook position of reflector 14 and 15, with transverse symmetry plane of Rod Lens parallel to light-outputting surface abml of LGP, and reflected light illuminates light-entering face abcd of LGP or some portion of light-entering face of LGP.

The design of the third to the sixth preferred embodiments' reflector 13 is the same as described in The second mode reflector and The third mode reflector of Detailed description of reflectors' designing.

The 3-dimentional shape of reflector 14 or 15 is a transversely inflected surface. The latitudinal curve of reflector 14 or 15 is a parabolic segment, with parabola's symmetry axis being vertical to light-entering face abcd, and length of parabola's projection on light-entering face abcd being half length of light-entering face ab, therefore the latitudinal boundaries 133, 134, 135 and 136 of reflector 14 and 15 are parabolic segments.

As illustrated in part 2 of FIG. 9, according to Rod Lens' orientation mentioned above, Rod Lens packaged LED emits light which is parallel Y-axis-direction-wise, therefore it is not necessary for reflector 14 or 15 to utilize the longitudinally inflected curve along Z-axis-direction to get Y-axis-direction parallel reflected light, since straight line can reflect light, which parallel each other and have zero incident angle, into light which parallel each other and have zero reflected angle, thus the longitudinal curves of reflector 14 and 15 are straight line, and longitudinal boundaries 131 and 132 of generic reflector 13 are straight line segments.

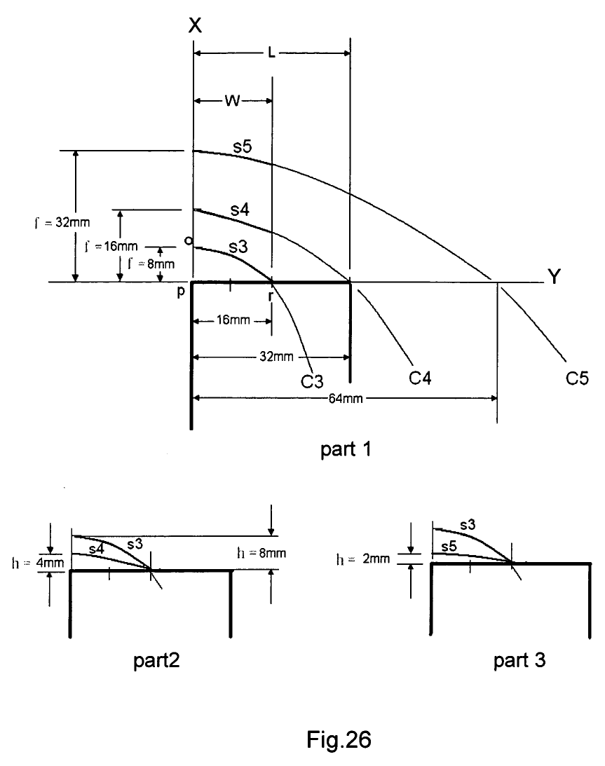

FIG. 26 illustrates further detailed description of design of some specific reflectors of the second and the third mode. In part 1 of FIG. 26, with length of light-entering of LGP L=32 mm, p being the focus, the longer side of light-entering face being Y-axis, direction vertical to Y-axis being X-axis, there are three coordinate systems superimposed in part 1 of FIG. 26, and each corresponds to parabola C3, C4, and C5 defined by equation Y²=4fx=4(nL/4)x; each parabola has its focal length f 8 mm, 16 mm or 32 mm separately, and it means that the n in said equation is 1, 2 or 4, and focal length f is 1*(32/4), 2*(32/4) or 4*(32/4) separately. The parabolas C3, C4 and C5 have the common focus p; each said parabola's vertex is different, in fact, each vertex is also origin point of the coordinate system corresponding to C3, C4 or C5 separately, however, those vertexes are all on the symmetry axis i.e. X-axis.

Parabolic segments S3, S4 and S5 are defined (determined) to be reflectors by sectioning parabolas C3, C3 and C5, with length of said parabolic segments' projections on “line vertical to symmetry axis” i.e. Y-axis being w=L/2=16 mm, and said length being measured from symmetry axis i.e. X-axis i.e. Y=0. One of each said parabolic segment's end would be corresponding origin point of said parabolas i.e. vertex of C3, C4 or C5.

As illustrated in part 2 and part 3 of FIG. 26, a specific reflector or half of a generic reflector is formed by moving S3, S4, or S5 toward light-entering face till the end far away from vertex contacts light-entering face and matching with light source located at nook point, and another specific reflector is symmetrical to the said one.

As the length of parabolic segments' projections is measured from symmetry axis Y=0, the “k” in formula h=|x1−x2|=|L/4n+k/n| will be 0, and “h” the largest distance between reflector and light-entering face will be 32/(4*1) [symbol] 32/(4*2) [symbol] 32/(4*4) when “n” is 1, 2 or 4 and reflector is S3, S4 or S5 separately.

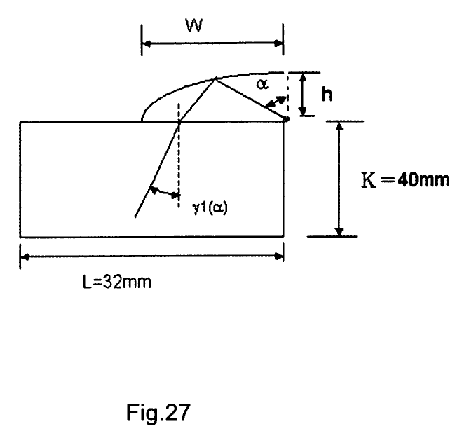

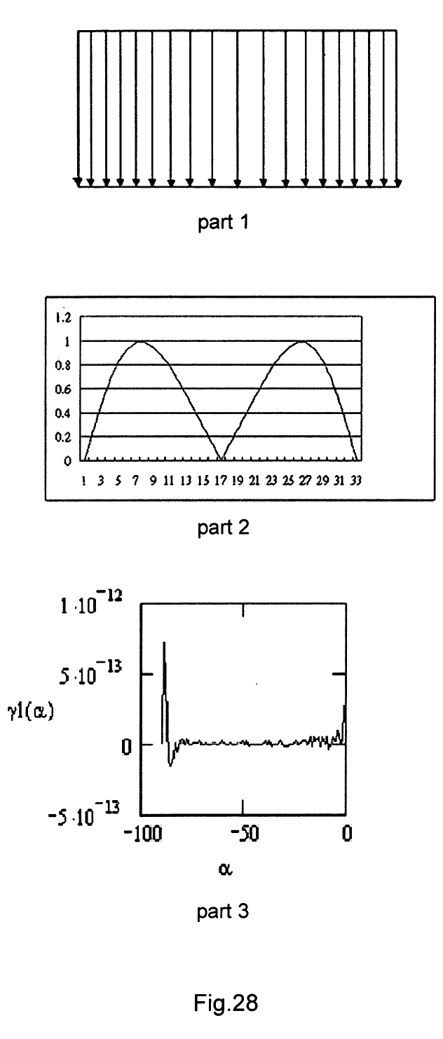

Each of FIG. 28 to FIG. 31 illustrates relation between incident angle α and reflective angle γ1(α), energy and vector distribution inside LGP of the third to the sixth preferred embodiment. Incident angle α and reflective angle γ1(α) are defined in FIG. 27 wherein L is length of light-entering face's longer side; w is length of half light-entering face's longer side; h is the largest distance between reflector and light-entering face; K is length of lateral side vertical to light-entering face; α is the angle formed by ray of incident light beam and line vertical to longer side of light-entering face; γ1(α) is the angle formed by ray, which is reflected by reflector and enters LGP, and line vertical to longer side of light-entering face, and γ1 is the function of α.

FIG. 28 illustrates the third preferred embodiment, wherein n=1, k=0; h=|L/4n+k/n|=|32/(4*1)+0/1|=8(mm), and f=nL/4=32/(4*1)=8(mm), so h—the largest distance between reflector and light-entering face equals f—the focal length, thus Rods Lens packaged LED is located at focus.

Therefore, as illustrated in part 3 of FIG. 28, when α—the incident angle ranges from 0 to near 90 degrees, γ1(α) will always be 0 degrees, i.e. the angles formed by rays, which are reflected by reflector and enter LGP, and line vertical to longer side of light-entering face will all be 0 degree, thus all the said rays are vertical to light-entering face, as illustrated in part 1 of FIG. 28.

Part 2 of FIG. 28 illustrates energy distribution along the line having distance of 20 mm from light-entering face, with transverse axis representing position, and longitudinal axis representing ratio of each position's intensity to the highest outputting intensity of Rod Lens packaged LED.

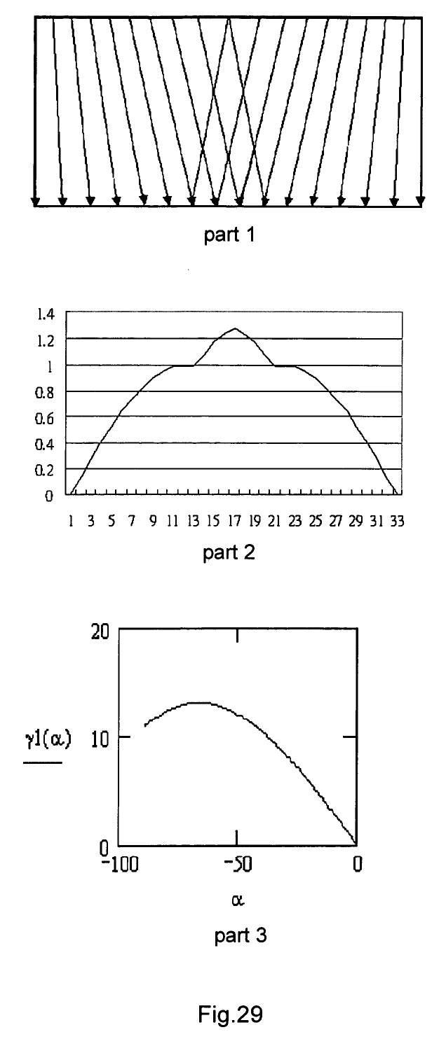

FIG. 29 illustrates the fourth preferred embodiment, wherein n=4/3, k=0 (this embodiment has not shown in FIG. 26); h=|L/4n+k/n|=|32/(4*4/3)+0/4/3|=6(mm), and h—the largest distance between reflector and light-entering face is reduced to be (1/n)*(L/4)=(3/4)*(8)=6(mm).

As illustrated in part 3 of FIG. 29, γ1(α) increases from 0 degree to the maximum of 12.5 degrees, and then decreases. Therefore, as illustrated in part 1 of FIG. 29, the rays which are reflected by reflector and enter LGP will be vertical to light-entering face at boundary, where γ1(α)=0, and deviate gradually till the maximum deviation of γ1(α)=12.5, then deviation decreases.

Part 2 of FIG. 29 illustrates energy distribution along the line having distance of 20 mm from light-entering face, with transverse axis representing position, and longitudinal axis representing ratio of each position's intensity to the highest outputting intensity of Rod Lens packaged LED. In contrast with part 2 of FIG. 28, of the third embodiment, which has twin peaks, part 2 of FIG. 29, of the fourth embodiment, has a plateau with only single peak, and the evenness of energy distribution increases.

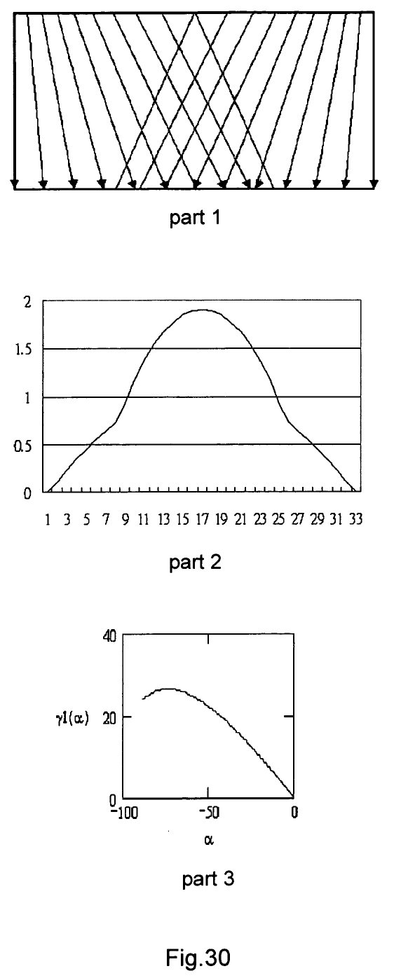

FIG. 30 illustrates the fifth preferred embodiment, wherein n=2, k=0; h=|L/4n+k/n|=|32/(4*2)+0/2|=4(mm), and h—the largest distance between reflector and light-entering face is reduced to be (1/n)*(L/4)=(1/2)*(8)=4(mm).

As illustrated in part 3 of FIG. 30, γ1(α) increases from 0 degree to the maximum of 27 degrees, and then decreases. Therefore, as illustrated in part 1 of FIG. 30, the rays which are reflected by reflector and enter LGP will be vertical to light-entering face at boundary, where γ1(α)=0 degree, and deviate gradually till the maximum deviation of γ1(α)=27 degrees, then deviation decreases. In contrast with part 3 of FIG. 29, of the fourth embodiment, which has maximum γ1(α) of 12.5 degrees, part 3 of FIG. 30, of the fifth embodiment, has maximum γ1(α) of 27 degrees, and the orientation of reflected light vector decreases.

Part 2 of FIG. 30 illustrates energy distribution along the line having distance of 20 mm from light-entering face, with transverse axis representing position, and longitudinal axis representing ratio of each position's intensity to the highest outputting intensity of Rod Lens packaged LED. In contrast with part 2 of FIG. 29, of the fourth embodiment, which has a plateau with only single peak, part 2 of FIG. 30, of the fifth embodiment, has a single peak with moderately changing curvature, and the evenness of energy distribution is better than the fourth preferred embodiment.

FIG. 30 illustrates the sixth preferred embodiment, wherein n=4, k=0; h=|L/4n+k/n|=|32/(4*4)+0/4|=2(mm), and h—the largest distance between reflector and light-entering face is reduced to be (1/n)*(L/4)=(1/4)*(8)=2(mm).

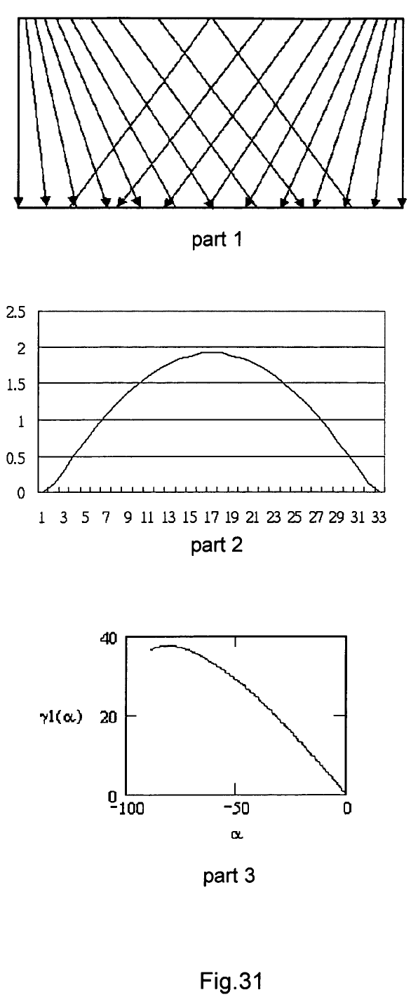

As illustrated in part 3 of FIG. 31, γ1(α) increases from 0 degree to the maximum of 38 degrees, and then decreases. Therefore, as illustrated in part 1 of FIG. 31, the rays which are reflected by reflector and enter LGP will be vertical to light-entering face at boundary, where γ1(α)=0 degree, and deviate gradually till the maximum deviation of γ1(α)=38 degrees, then deviation decreases. In contrast with part 3 of FIG. 30, of the fifth embodiment, which has maximum γ1(α) of 27 degrees, part 3 of FIG. 30, of the sixth embodiment, has maximum γ1(α) of 38 degrees, and the orientation of reflected light vector decreases further.

Part 2 of FIG. 31 illustrates energy distribution along the line having distance of 20 mm from light-entering face, with transverse axis representing position, and longitudinal axis representing ratio of each position's intensity to the highest outputting intensity of Rod Lens packaged LED. In contrast with part 2 of FIG. 30, of the fifth embodiment, which has a single peak with moderately changing curvature, part 2 of FIG. 31, of the sixth embodiment, has a single peak with even more moderately changing curvature, and the evenness of energy distribution is better than the fifth preferred embodiment.

It can be concluded from FIG. 28 to FIG. 31 that, in the case k=0, as n increases, energy evenness increases, and vector orientation decreases, but is still obviously superior to that of the conventional LED light source, moreover, h—the largest distance between reflector and light-entering face decreases rapidly in rate of 1/n, and illuminator's occupied space is reduced obviously. In the present invention of illuminator, suitable n, h, k i.e. parabola of reflector, sectioning position, the largest distance between reflector and light-entering face, can be adopted according to the backlight module's need for orientation, evenness and space to achieve aim of design.

1. An illuminator, including one or a plurality of light sources and one or a plurality of reflectors, characterized in that said light sources are located at nook position.

2. An illuminator, including one or a plurality of light sources and one or a plurality of reflectors, characterized in that said light sources are located at nook position, and the reflectors can be designed elastically according to requirement of mode of reflected light vector distribution in space and mode of reflected light intensity distribution on illuminated surface.

3. An illuminator, including one or a plurality of light sources and one or a plurality of reflectors, characterized in that said light sources are located at nook position, and the reflectors can be designed elastically according to requirement of mode of reflected light vector distribution in space and mode of reflected light intensity distribution on illuminated surface, and adjusting the united architecture of light source and reflector by rotation or translation can change the reflected light vector's orientations.

4. An illuminator according to claim 3, wherein said reflector has a connecting part, and said light source is located at said connecting part.

5. An illuminator according to claim 3, wherein said light source is light emitting diode LED.

6. An illuminator according to claim 3, wherein said light source is Rod Lens packaged LED.

7. An illuminator according to claim 6, wherein reflecting plates are equipped on both lateral sides of Rod Lens.

8. An illuminator according to claim 3, wherein illuminated face of reflected light is light-entering face of light guide plate LGP.

9. An illuminator according to claim 3, wherein illuminated face of reflected light is a portion of light-entering face of light guide plate LGP.

10. An illuminator according to claim 3, wherein both faces of said reflector contact air directly.

11. An illuminator according to claim 3, wherein said reflector is made of ceramics or metal of high thermal conductivity materials, including cupric, aluminum, and ferric categories.

12. An illuminator, including one or a plurality of light sources and one or a plurality of reflectors, characterized in that said light source is located at nook position; the 3-dimensional shape of said reflector is inwards inflected surface; the transverse curves of said reflector are to make energy of reflected light evenly distributed on illuminated face, and longitudinal curves are the parabolic segments, with said nook-positioned light source being common focus, vertexes of said parabolic segments being located at a said transverse curve.

13. An illuminator according to claim 12, wherein adjusting the united architecture of said light source and said reflector by rotation or translation can change the reflected light vector's orientations.

14. An illuminator according to claim 12, wherein light source is LED.

15. An illuminator, including one or a plurality of light sources and one or a plurality of reflectors, characterized in that said light source is located at nook position; when viewed from certain orientation, the vectors of light emitted from said light source appear to be parallel to each other; the 3-dimensional shape of said reflector is inwards inflected surface; the transverse curves of said reflector are to make energy of reflected light evenly distributed on illuminated face, and longitudinal curves of said reflector are straight line segments.

16. An illuminator according to claim 15, wherein said light source is Rod Lens packaged LED.

17. An illuminator according to claim 16, wherein illuminated face of reflected light is light-entering face of light guide plate LGP.

18. An illuminator, including one or a plurality of light sources and one or a plurality of reflectors, characterized in that said light source is located at nook position; in the case that long side of illuminated face of reflected light is set as X-axis, short side of illuminated face of reflected light as Y-axis, and direction vertical to X-axis and Y-axis as Z-axis, vectors of reflected light tend to be parallel distributed when viewed along X-axis; vectors of reflected light are distributed in sector-like way when viewed Z-axis, and energy distribution of reflected light on illuminated face tends to be even.

19. An illuminator according to claim 18, wherein illuminated face of reflected light is light-entering face of light guide plate LGP.

20. An illuminator, including two light sources and two reflectors, characterized in that said two reflectors are symmetrical to each other; each of said reflectors is equipped with a said light source; each of said light sources is located at nook position of corresponding reflector separately; light emitted from said light sources appears to be parallel as viewed from a certain orientation; the 3-dimensional shapes of said reflectors are transversely inflected surfaces; the transverse curves of said reflectors are parabolic segments and the longitudinal curves of said reflectors are straight line segments.

21. An illuminator according to claim 20, wherein the symmetry axes of said parabolic segments are vertical to reflected light's illuminated face, and projection's length of said parabolic segments on illuminated face equals half length of illuminated face.

22. An illuminator according to claim 20, wherein illuminated face of reflected light is light-entering face of light guide plate LGP.

23. An illuminator, including two light sources and two reflectors, characterized in that said two reflectors are symmetrical to each other; each of said reflectors is equipped with a said light source; each of said light sources is located at nook position of corresponding reflector separately; the said light sources are Rod Lens packaged light emitting diodes LEDs; the illuminated face of reflected light is light-entering face of light guide plate LGP; the 3-dimensional shapes of said reflectors are transversely inflected surfaces; the transverse curves of said reflectors are parabolic segments; the symmetry axes of said parabolic segments are vertical to reflected light's illuminated face; projection's length of said parabolic segments on illuminated face equals half length of illuminated face and the longitudinal curves of said reflectors are straight line segments.

24. An illuminator according to claim 23, wherein said each of light sources is set to be common focus of said parabolic segments of corresponding reflector.

25. An illuminator, including one or a plurality of light sources and one or a plurality of reflectors, characterized in that said light source is located at nook position, the design steps of said reflectors includes:
determining position of light source, which is located at nook position of reflector;
determining latitudinal center curve of reflector which makes light's energy, reflected from said center curve of reflector, tend to be evenly distributed on latitudinal center line of light-entering face;
determining longitudinal curves or straight lines of reflector which make reflected light's vectors parallel to a given orientation;
determining reflector by combining said latitudinal center line and a plurality of said longitudinal curves or straight lines.

26. An illuminator,
including one light source and one reflector,
characterized in that
said light source is located at nook position;
said light source includes light emitting diode;
the illuminated face of reflected light is light-entering face of light guide plate LGP;
the design processes of said reflector include:
process A, which is to determine latitudinal center curve of reflector, which makes light's energy, reflected from said latitudinal center curve of reflector, evenly distributed on latitudinal center line of light-entering face, by means of finite elements method, according to reflective law of optics,
with process A further comprising the following steps
(1) dividing light source energy by angle into N equal-energy elements, wherein N is a natural number;
(2) dividing latitudinal center line of light-entering face into N equal-length elements;
(3) matching each of said N equal-energy elements with corresponding one of said N equal-length elements according to a certain rule;
(4) determining light source position;
(5) determining the initial reflecting point of said latitudinal center curve of reflector from the first emitted ray associated with the first equal-energy element;
(6) determining the first emitting optical path by connecting said light source position with said initial reflecting point of latitudinal center curve of reflector;
(7) determining the first reflected optical path by connecting said initial reflecting point of latitudinal center curve of reflector with the first equal-length element determined by said matching in (3);
(8) determining the first normal (at the initial reflecting point) of latitudinal center curve of reflector from bisector of the angle formed by said first emitting optical path and said first reflected optical path, according to reflective law;
(9) determining the first tangential (at the initial reflecting point) from said first normal;
(10) determining the second reflecting point by intersecting point of the first tangential and the second emitted ray associated with the second equal-energy element;
(11) determining the second emitting optical path by connecting said light source position with said second reflecting point;
(12) determining the second reflected optical path by connecting said second reflecting point with the second equal-length element determined by said matching in (3);
(13) determining the second normal (at said second reflecting point) of latitudinal center curve of reflector from bisector of the angle formed by said second emitting optical path and said second reflected optical path, according to reflective law;
(14) determining the second tangential (at said second reflecting point) from said second normal;
(15) repeating step (10) to (14) until said equal-energy elements and equal-length elements are exhausted, and N reflecting points of latitudinal center curve have been determined;
(16) determining latitudinal center curve of reflector from said N reflecting points of latitudinal center curve;
process B, which is to determine longitudinal curves of reflector, which make reflected light's vectors parallel to a given orientation, with process B further comprising the following steps:
(1) connecting each of said reflecting points of latitudinal center curve of reflector with light source to form N line segments;
(2) producing N parabolas, with each of said reflecting points of said latitudinal center curve of reflector being vertex, each corresponding line segment being focal length, and said light source being common focus;
(3) sectioning each said parabola with extended planes of LGP's light-outputting surface and its opposite surface 7 to produce N parabola's segments, each of which make reflected light's vectors parallel to a given orientation;
process C, which is to determine said reflector by combining said “latitudinal center curve of reflector” and said “N parabola's segments”.

27. An illuminator according to claim 26, wherein “a portion of light-entering face of LGP” takes the place of “light-entering face of LGP”; “a portion of latitudinal center line” takes the place of “latitudinal center line”; said reflector has a connecting part, and LED is located at said connecting part.

28. An illuminator according to claim 26, wherein adjusting the united architecture of light source and reflector by rotation or translation can change the reflected light vector's orientations.

29. An illuminator, including one light source and one reflector, characterized in that said light source is located at nook position; light vectors emitted from said light source appear to be parallel to the light-outputting surface of LGP as viewed from a certain orientation; the illuminated face of reflected light is light-entering face of light guide plate LGP; the design processes of said reflector include:
process A, which is to determine latitudinal center curve of reflector, which makes light's energy, reflected from said latitudinal center curve of reflector, evenly distributed on latitudinal center line of light-entering face, by means of finite elements method, according to reflective law of optics,
with process A further comprising the following steps:
(1) dividing light source energy by angle into N equal-energy elements, wherein N is a natural number;
(2) dividing latitudinal center line of light-entering face into N equal-length elements;
(3) matching each of said N equal-energy elements with corresponding one of said N equal-length elements according to a certain rule;
(4) determining light source position;
(5) determining the initial reflecting point of said latitudinal center curve of reflector from the first emitted ray associated with the first equal-energy element;
(6) determining the first emitting optical path by connecting said light source position with said initial reflecting point of latitudinal center curve of reflector;
(7) determining the first reflected optical path by connecting said initial reflecting point of latitudinal center curve of reflector with the first equal-length element determined by said matching in (3);
(8) determining the first normal (at the initial reflecting point) of latitudinal center curve of reflector from bisector of the angle formed by said first emitting optical path and said first reflected optical path, according to reflective law;
(9) determining the first tangential (at the initial reflecting point) from said first normal;
(10) determining the second reflecting point by intersecting point of the first tangential and the second emitted ray associated with the second equal-energy element;
(11) determining the second emitting optical path by connecting said light source position with said second reflecting point;
(12) determining the second reflected optical path by connecting said second reflecting point with the second equal-length element determined by said matching in (3);
(13) determining the second normal (at said second reflecting point) of latitudinal center curve of reflector from bisector of the angle formed by said second emitting optical path and said second reflected optical path, according to reflective law;
(14) determining the second tangential (at said second reflecting point) from said second normal;
(15) repeating step (10) to (14) until said equal-energy elements and equal-length elements are exhausted, and N reflecting points of latitudinal center curve have been determined;
(16) determining latitudinal center curve of reflector from said N reflecting points of latitudinal center curve;
process B, which is to determine longitudinal curves of reflector, which make reflected light's vectors parallel to a given orientation,
with process B further comprising the following steps:
(1) determining N straight lines vertical to light-outputting surface of LGP, and intersecting said N reflecting points of said latitudinal center curve of reflector separately;
(2) sectioning each of said straight lines with extended planes of LGP7's light-outputting surface and its opposite surface to produce N straight line segments, each of which make reflected light's vectors parallel to a given orientation;
process C, which is to determine said reflector by combining said “latitudinal center curve of reflector” and said “N straight line segments”.

30. An illuminator according to claim 29, wherein said light source is Rod Lens packaged LED, and the longitudinal symmetry plane of said Rod Lens is parallel to light-outputting surface of LGP.

31. An illuminator according to claim 29, wherein “a portion of light-entering face of LGP” takes the place of “light-entering face of LGP”; “a portion of latitudinal center line” takes the place of “latitudinal center line”; said reflector has a connecting part, and LED is located at said connecting part.

32. An illuminator according to claim 26, wherein in the local portion where longitudinal width of reflector is shorter than width of longitudinal side of LGP's light-entering face, “parabola with light source not at its focus” takes the place of “parabola with light source at its focus”.

33. An illuminator,
including two light sources and two reflectors,
characterized in that
said two reflectors are symmetrical to each other;
each of said reflectors is equipped with a said light source;
each of said light sources is located at nook position of corresponding reflector separately;
the illuminated face of reflected light is light-entering face of light guide plate LGP;
light vectors emitted from said light source appear to be parallel to light-outputting surface as viewed from a certain orientation;
in the case that
long side of light-entering face of LGP is X-axis, direction vertical to light-entering face Y-axis, short side of light-entering face Z-axis;
A is transverse axis of another coordinate system, B longitudinal axis of said another coordinate system;
the length scale of A-B coordinate system is the same as that of light-entering face;
L is length of long side of light-entering face;
and n is a real number equaling or larger than 1;
the design processes of said reflectors include:
sectioning a partial parabolic segment from parabola defined by equation B²=4(nL/4)A, with length of said partial parabolic segment's projection on “line vertical to symmetry axis of said parabola” being L/2;
determining a plurality of straight lines, as longitudinal curves of reflector, vertical to X-Y plane and intersecting a plurality of points of said parabolic segment separately;
sectioning each of said straight lines with extended planes of LGP's light-outputting surface and its opposite surface to produce a plurality of line segments;
combining said partial parabolic segments and said a plurality of line segments to form a reflector;
determining another reflector which is symmetrical to the reflector having been formed.

34. An illuminator according to claim 33, wherein the light source is Rod Lens packaged LED, and the longitudinal symmetry plane of Rod Lens is parallel to light-outputting surface of LGP.

35. An illuminator according to claim 33, wherein said reflector has a connecting part, and said light source is located at said connecting part.

36. An illuminator according to claim 33, wherein the parabolic segment's end, which is far away from vertex of said parabola defined by equation B²=4(nL/4)A, contacts light-entering face.

37. An illuminator according to claim 33, wherein length L/2 of said partial parabolic segment's projection on “line vertical to symmetry axis of said parabola” is measured from straight line defined by equation B=k, and k is a real number larger than (−L/4).

38. An illuminator according to claim 33, wherein length L/2 of said partial parabolic segment's projection on “line vertical to symmetry axis of said parabola” is measured from the straight line which is vertical to symmetry axis of said parabola and passes through vertex of said parabola i.e. straight line defined by B=0.

39. An illuminator,
including two light sources and two reflectors,
characterized in that
said two reflectors are symmetrical to each other;
each of said reflectors is equipped with a said light source;
each of said light sources is located at nook position of corresponding reflector separately;
the illuminated face of reflected light is light-entering face of light guide plate LGP;
said light source is Rod Lens packaged LED, with the longitudinal symmetry plane of Rod Lens being parallel to light-outputting surface of LGP;
in the case that
long side of light-entering face of LGP is X-axis, direction vertical to light-entering face Y-axis, short side of light-entering face Z-axis;
A is transverse axis of another coordinate system, B longitudinal axis of said another coordinate system;
the length scale of A-B coordinate system is the same as that of light-entering face;
L is length of long side of light-entering face;
and n is a real number equaling or larger than 1;
the design processes of said reflectors include:
sectioning a partial parabolic segment from parabola defined by equation B²=4(nL/4)A, with length of said partial parabolic segment's projection on “line vertical to symmetry axis of said parabola” being L/2 and length L/2 being measured from straight line defined by equation B=k, and k being a real number larger than (−L/4);
determining a plurality of straight lines, as longitudinal curves of reflector, vertical to X-Y plane and intersecting a plurality of points of said parabolic segment separately;
sectioning each of said straight lines with extended planes of LGP's light-outputting surface and its opposite surface to produce a plurality of line segments;
making the parabolic segment's end, which is far away from vertex of said parabola, contact light-entering face;
combining said partial parabolic segments and said a plurality of line segments to form a reflector;
determining another reflector which is symmetrical to the reflector having been formed.

40. An illuminator according to claim 39, wherein n=1 and k=0.

41. An illuminator according to claim 39, wherein said reflector has a connecting part, and said light source is located at said connecting part.

42. An illuminator according to claim 39, wherein adjusting the united architecture of said light source and said reflector by rotation or translation can change the reflected light vector's orientations.

43. An illuminator according to claim 39, wherein reflecting plates are equipped on both lateral sides of Rod Lens.

44. An illuminator according to claim 39, wherein both faces of said reflector contact air directly.

45. An illuminator according to claim 39, wherein said reflector is made of ceramics or metal of high thermal conductivity materials, including cupric, aluminum, and ferric categories.
